(19) United States
(12) Patent Application Publication
(10) Pub. No.: US 2014/0344920 A1
(43) Pub. Date: Nov. 20, 2014

(54) METHOD, TERMINAL, AND SERVICE DEVICE FOR PROVIDING DATA SECURITY SERVICE

(71) Applicant: Sok Hyun JUNG, Namyangju-si (KR)

(72) Inventor: Sok Hyun JUNG, Namyangju-si (KR)

(21) Appl. No.: 14/276,228

(22) Filed: May 13, 2014

(30) Foreign Application Priority Data
May 16, 2013 (KR) 10-2013-0055625
May 22, 2013 (KR) 10-2013-0057635
May 23, 2013 (KR) 10-2013-0058128

(51) Int. Cl. G06F 21/62

(52) U.S. Cl. CPC G06F 21/6218
USPC 726/17

(57) ABSTRACT

Disclosed are a method, a terminal, and a service device for providing a data security service for data stored in a terminal or a data security service for backup data of the data of the terminal, backed up onto a backup device.

### CROSS-REFERENCE TO RELATED APPLICATION

This application claims priority from and the benefit under 35 U.S.C. §119(a) of Korean Patent Application Nos. 10-2013-0055625, 10-2013-0057635, 10-2013-0058128, filed on May 16, 2013, May 22, 2013, & May 23, 2013, which are hereby incorporated by reference for all purposes as if fully set forth herein.

### BACKGROUND OF THE INVENTION

1. Field of the Invention

The present invention relates to a method, a terminal, and a service apparatus for providing a data security service.

2. Description of the Prior Art

Nowadays users frequently use terminals, such as a smart phone, a tablet Personal Computer (PC) and the like and store, in the terminal, personal and private data or data which should not be leaked to other people.

Accordingly, when the user loses the terminal and a malicious or nonauthorized user finds the lost terminal, data stored in the terminal may be leaked and maliciously used.

In this case, the user having lost the terminal may receive psychological and monetary damage due to the data leakage.

### SUMMARY OF THE INVENTION

Under such a background, the present invention can provide a data security service for data stored in a terminal.

Further, the present invention can provide a data security service for back up data of the data stored in the terminal backed up onto a backup device.

In accordance with an aspect of the present invention, a terminal providing a data security service is provided. The terminal may comprise: a storage unit for storing unlocking reference information input for unlocking; an input unit for receiving unlocking request information for the unlocking in a locking state; and a controller for comparing the unlocking reference information and the unlocking request information, changing the locking state to an unlocking state when it is determined that the unlocking reference information and the unlocking request information are identical, and maintaining the locking state when it is determined that the unlocking reference information and the unlocking request information are different, wherein the controller performs a security process defined according to a count of cases where it is determined that the unlocking reference information and the unlocking request information are different through the comparison therebetween.

In accordance with another aspect of the present invention, a service device providing a data security service is provided. The service device may comprise: a service execution unit for transmitting a data removal command for removing data stored in an internal or external storage device of a first terminal to the first terminal one or more times according to an execution request for a terminal data security service, receiving a data removal result, and processing a response to the execution request according to the data removal result; and a communication unit for communicating with the first terminal.

In accordance with another aspect of the present invention, a terminal providing a data security service is provided. The terminal may comprise: an internal or external storage device for storing data; a data removal processor for, when receiving a data removal command for removing the data stored in the internal or external storage device from a service device, performing a data removal process for the internal or external storage device and transmitting a data removal result to the service device; and a communication unit for communicating with the service device.

### BRIEF DESCRIPTION OF THE DRAWINGS

FIG. 1 schematically illustrates a data security system to which embodiments of the present invention are applied;

FIG. 2 is a block diagram of a first terminal providing a terminal data security service according to an embodiment of the present invention;

FIG. 3 is a flowchart illustrating a method of providing a terminal data security service of a first terminal according to an embodiment of the present invention;

FIG. 4 illustrates a concept of a terminal data security service according to another embodiment of the present invention;

FIG. 5 is a block diagram of a service device for a terminal data security service according to another embodiment of the present invention;

FIG. 6 is a block diagram of a first terminal for a terminal data security service according to another embodiment of the present invention;

FIG. 7 is a flowchart illustrating a terminal data security service method of a service device according to another embodiment of the present invention;

FIG. 8 is a flowchart illustrating a terminal data security service method of a first terminal according to another embodiment of the present invention;

FIG. 9 illustrates a concept of a backup data security service according to another embodiment of the present invention;

FIG. 10 is a block diagram of a service device according to another embodiment of the present invention;

FIG. 11 is a block diagram of a backup device according to another embodiment of the present invention;

FIG. 12 is a block diagram of a first terminal according to another embodiment of the present invention;

FIG. 13 is a flowchart illustrating a backup data security service method of a service device according to another embodiment of the present invention;

FIG. 14 is a flowchart illustrating a backup data security service method of a backup device according to another embodiment of the present invention;

FIG. 15 is a flowchart illustrating a backup data security service method of a first terminal according to another embodiment of the present invention; and

FIG. 16 illustrates an example of a screen of an interface provided by a first terminal to register a backup data security service according to another embodiment of the present invention.

### DETAILED DESCRIPTION OF THE EXEMPLARY EMBODIMENTS

Hereinafter, exemplary embodiments of the present invention will be described with reference to the exemplary drawings. Further, in the following description of the present invention, a detailed description of known functions and configurations incorporated herein will be omitted when it may make the subject matter of the present invention rather unclear.

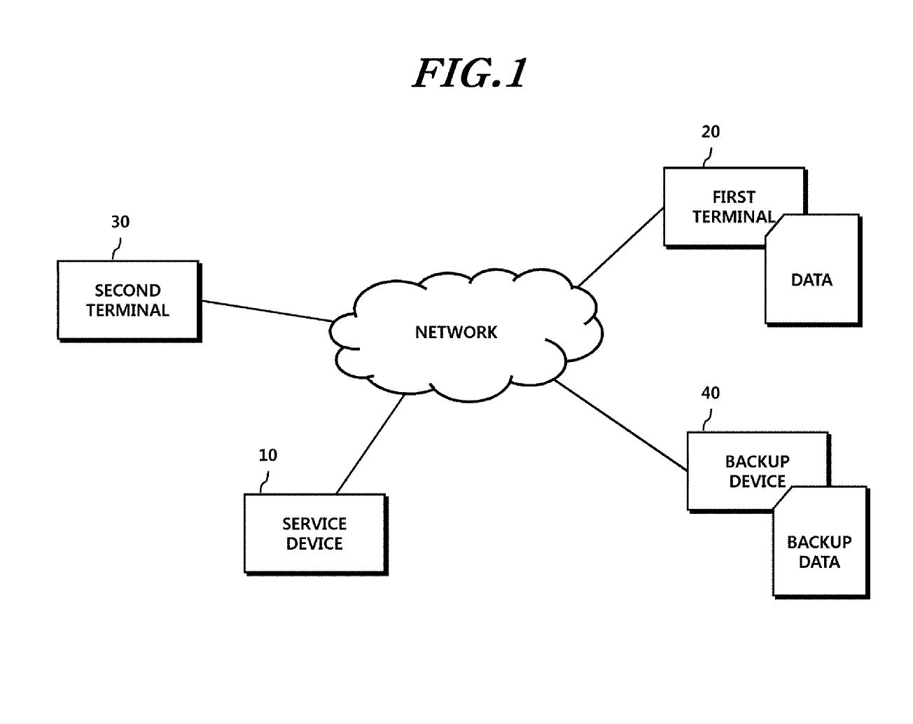

FIG. 1 schematically illustrates a data security system to which embodiments of the present invention are applied.

Referring to FIG. 1, a data security service system according to embodiments of the present invention is a system providing a data security service for data related to a first terminal 20 to be secured, belonging to the user.

The data security service for data related to the first terminal 20 may be “terminal data security service” for data stored in an internal and/or external memory of the first terminal 20 to be secured, belonging to the user.

The data security service for the data related to the first terminal 20 may be “backup data security service (backup data removal service)” for backup data of the data stored in the internal and/or external memory of the first terminal 20 of the user, which is stored in a backup device 40.

The terminal data security service may be provided alone by the first terminal 20 without any assistance from another device or provided through an interworking with another device (service device 10).

The backup data security service may be provided through an interworking between the first terminal 20 and another device (service device 10).

When the terminal data security service and the backup data security service are provided through the interworking between the first terminal 20 and another device (service device 10), the data security service system according to embodiments of the present invention may include the service device 20 for providing the data security service and a second terminal 30 to which the user of the first terminal 20 or an acquaintance thereof makes a request for executing the data security service.

When the backup data security service is provided through the interworking between the first terminal and another device (service device 10), the data security service system according to embodiments of the present invention may further include the backup device 40 for backing up and storing data stored in the internal and/or external memory of the first terminal 20 of the user.

The service device 10 may be a device operated by a communication service provider of the first terminal 20. The backup device 40 may be generally a device operated by the communication service provider of the first terminal 20, or a device operated by a terminal manufacturer or an Operating System (OS) manufacturer of an OS installed in the first terminal 20.

For example, the data security service according to embodiments of the present invention may be used for removing data stored in the first terminal 10 or backup data of the data when the user does not have the first terminal 10 in a case where a state the data stored in the first terminal 20 of the user should be removed is generated due to a particular reason.

More specifically, the data security service according to embodiments of the present invention may be used as a service for preventing, when the user loses the first terminal 20, a risk that private data or data to be secured, stored in the lost first terminal 20, is leaked to another malicious user.

Further, when the data security service according to embodiments of the present invention is provided, a security means which allows a malicious user (for example, user who gets the lost first terminal 20) or a user who may thoughtlessly use the first terminal 10 (for example, child of the user) to not carelessly remove private or secure data stored in the first terminal 20 or the backup device 40.

The first terminal 20 in the specification may include a general Personal Computer (PC) such as a general desktop or notebook and also include a mobile terminal such as a smart phone, a tablet PC, a Personal Digital Assistant (PDA) and a mobile communication terminal, but the first terminal 20 should be widely construed as any electronic device which can communicate with the server device 10.

Meanwhile, the service device 10, the first terminal 20, the second terminal 30, and the backup device 40 are connected through a network. The network may be a closed network such as a Local Area Network (LAN), a Wide Area Network (WAN) or the like, or an open network such as an Internet. When the first terminal 20 includes a mobile terminal such as a smart phone, a tablet PC, a PDA, and a mobile communication terminal, the network may further include a radio access network such as a mobile communication network, a WiFi network or the like.

Hereinafter, the data security service for the data stored in the internal and/or external memory of the first terminal 20 of the user will be first described.

In a description of the terminal data security service, the terminal data security service is divided into a terminal data security service provided by the first terminal 20 alone without any assistance from another external device and a terminal data security service provided through an interworking with an external another device.

Subsequently, a backup data security service for backup data of the data stored in the first terminal 20 of the user, which is stored in the backup device 40 will be described.

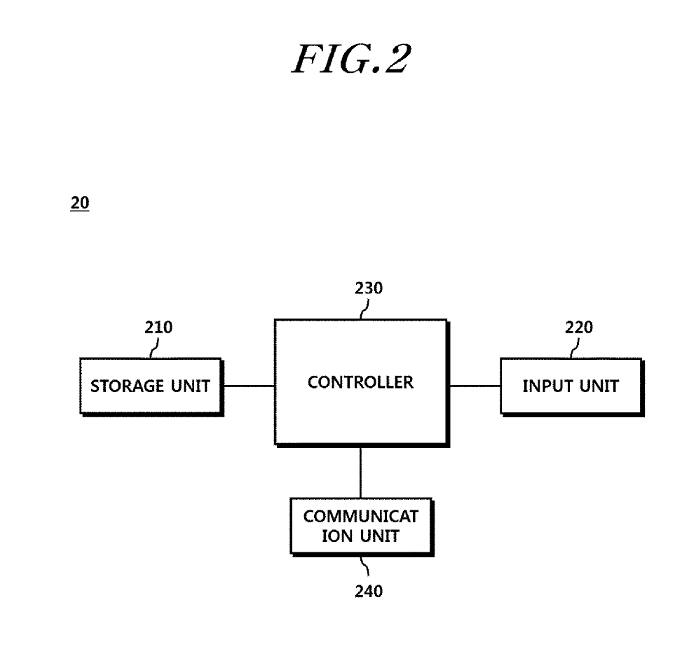

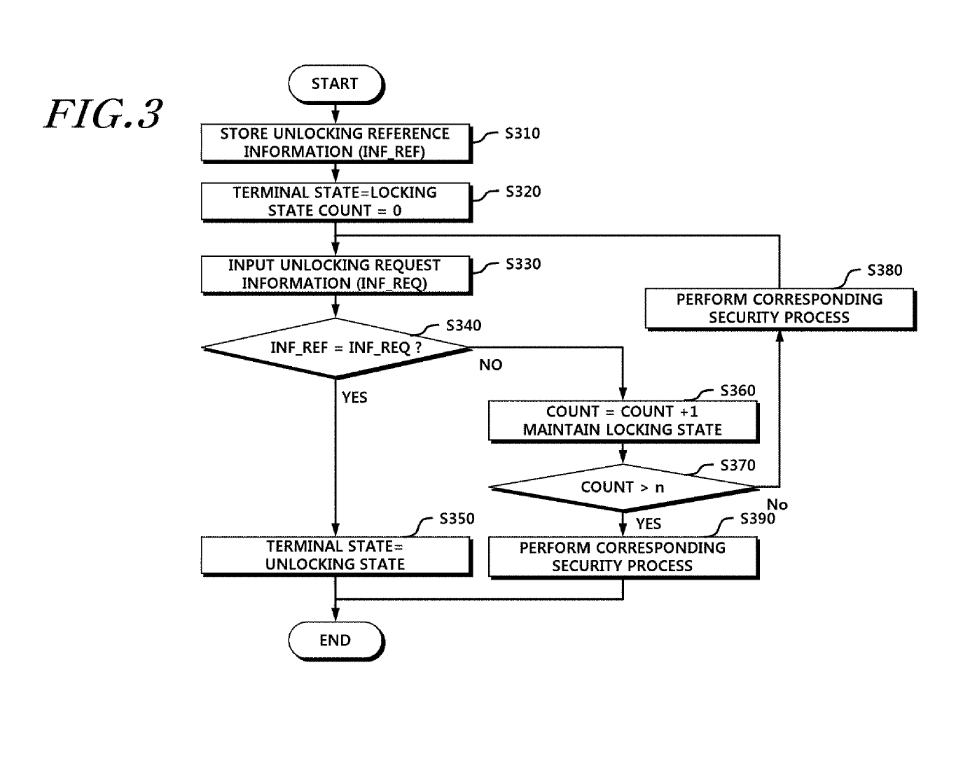

First, the terminal data security service provided by the first terminal 20 alone without any assistance from another external device will be described in more detail with reference to FIGS. 2 and 3.

FIG. 2 is a block diagram of the first terminal 20 providing the terminal data security service according to an embodiment of the present invention.

Referring to FIG. 2, the first terminal 20 providing the terminal data security service according to an embodiment of the present invention includes a storage unit 210 for storing unlocking reference information input for releasing the lock, an input unit 220 for receiving unlocking request information for releasing the lock in a locking state when a terminal state of the first terminal 20 is the locking state, and a controller 230 for comparing the unlocking reference information and the unlocking request information, changing the locking state to an unlocking state when the unlocking reference information and the unlocking request information are the same, and maintaining the locking state when the unlocking reference information and the unlocking request information are different.

The controller 230 may perform a defined security process according to a count of cases where it is determined that pre-stored unlocking reference information and unlocking request information currently input to release the lock are different through a comparison between the unlocking reference information and the unlocking request information.

For example, the controller 230 may perform a defined security process according to a count of continuous generations of cases where it is determined that pre-stored unlocking reference information and unlocking request information currently input to release the lock are different through a comparison between the unlocking reference information and the unlocking request information with reference to security processes defined differently according to the count.

The controller 230 will be described below in more detail.

When a count of the cases where it is determined that the pre-stored unlocking reference information and the unlocking request information currently input to release the lock are different through the comparison between the unlocking reference information and the unlocking request information is equal to or larger than 1 and equal to or smaller than n, the controller 230 may perform a security process of inputting again the unlocking request information and outputting information on an instruction of reattempting the unlocking. A value ‘n’, corresponding to a reference unlocking failure count compared with a count of an unlocking attempt failure count, may be configured in advance by a system or configured by the user.

Further, when a count of the cases where it is determined that the pre-stored unlocking reference information and the unlocking request information currently input to release the lock are different (that is, the unlocking failure count) exceeds n (the reference unlocking failure count), the controller 230 may perform a security process of initializing the first terminal 20, or may perform a security process of outputting an alert message indicating that the first terminal 20 may be initialized if the case where it is determined that the unlocking reference information and the unlocking request information are different is generated m more times.

Meanwhile, event after the first terminal 20 is initialized by performing the security process of initializing the first terminal 20, the controller 230 may control to maintain a configuration state of the unlocking type before the initialization of the first terminal 20 and maintain and store the unlocking reference information. Accordingly, after the initialization, the first terminal 20 may remain in an unavailable state.

To this end, configuration state information of the unlocking type, unlocking reference information and the like may be stored and managed in a memory region which is not removed by the initialization of the terminal.

Further, when a count of the cases where it is determined that the pre-stored unlocking reference information and the unlocking request information currently input to release the lock are different (that is, the unlocking failure count) exceeds n (the reference unlocking failure count), the controller 230 may perform a security process of initializing the first terminal 20 or may output an alert message indicating an initialization of the first terminal 20.

Further, when a count of the cases where it is determined that the pre-stored unlocking reference information and the unlocking request information currently input to release the lock are different (that is, the unlocking failure count) exceeds n (the reference unlocking failure count), the controller 230 may perform a security process of initializing the first terminal 20 or outputting an alert message indicating an initialization of the first terminal 20 when the case where it is determined that the unlocking reference information and the unlocking request information are different is generated m more times or authentication failure information according to one or more other authentication schemes (for example, authentication scheme based on a PIN number input) is generated.

Meanwhile, when the controller 230 performs the security process of outputting the alert message indicating the initialization of the first terminal 20, the controller may provide a user authentication process (it may be a user authentication process according to other aforementioned authentication schemes). When the user authentication is succeeded, the controller 230 may provide an interface by which the unlocking reference information can be known or reconfigured. The user authentication process may be performed through a comparison between authentication information pre-configured by the user and currently input authentication information.

The initialization of the first terminal 20 refers to making the first terminal 20 be in a state of shipment from a factory or a state before activation. At this time, the initialization may refer to making data stored in the external memory of the first terminal 20, a Universal Subscriber Identity Module (USIM), a Universal Integrated Circuit Card (UICC) or the like be in the state of shipment from the factory or the state before activation or formatting the data. Further, in the initialization of the first terminal 20, an external memory (for example, an SD card or the like) which can be inserted into and withdrawn from the first terminal 20 may be formatted.

When the count of the cases where it is determined that the pre-stored unlocking reference information and the unlocking request information currently input to release the lock are different through the comparison between the unlocking reference information and the unlocking request information exceeds n, the controller 230 may perform a security process of removing data stored in the first terminal 20 or perform a security process of outputting an alert message indicating that the data stored in the first terminal 20 may be removed.

Further, when the count of the cases where it is determined that the pre-stored unlocking reference information and the unlocking request information currently input to release the lock are different through the comparison between the unlocking reference information and the unlocking request information exceeds n, the controller 230 may perform the security process of removing the data stored in the first terminal 20 or perform the security process of outputting the alert message indicating that the data stored in the first terminal 20 may be removed if the case where it is determined that the unlocking reference information and the unlocking request information are different through the comparison thereof is generated m more times or authentication failure information according to one or more other authentication schemes (for example, authentication scheme based on a PIN number input) is generated.

Meanwhile, when the controller 230 performs the security process of outputting the alert message indicating that the data stored in the first terminal 20 may be removed, the controller 230 may provide a user authentication process (it may be a user authentication process according to other aforementioned authentication schemes). When the user authentication is succeeded, the controller 230 may provide an interface by which the unlocking reference information can be known or reconfigured. The user authentication process may be performed through a comparison between authentication information pre-configured by the user and currently input authentication information.

The data stored in the first terminal 20 may be data stored in an internal or external storage device (including a memory, a USIM, a UICC or the like and also the storage unit 210) of the first terminal 20, and include one or more of designated data, data stored in a designated position, and data having a designated file format according to a configuration by the user.

That is, the data stored in the first terminal 20 may be data stored in the internal memory of the first terminal 20.

Further, the data stored in the first terminal 20 may be data stored in a memory which can be inserted into and withdrawn from the first terminal 20.

When the count of the cases where it is determined that the pre-stored unlocking reference information and the unlocking request information currently input to release the lock are different through the comparison between the unlocking reference information and the unlocking request information exceeds n or when the security process of initializing the first terminal 20 is performed, the controller 230 may perform a security process of transmitting a terminal security emergency message (for example, a terminal loss message or a terminal theft message) to a management device (not shown) of a communication service company of the first terminal 20.

Alternatively, when the count of the cases where it is determined that the pre-stored unlocking reference information and the unlocking request information currently input to release the lock are different through the comparison between the unlocking reference information and the unlocking request information exceeds n, the controller 230 may perform the security process of transmitting the terminal security emergency message to the management device (not shown) of the communication service company of the first terminal 20 if the case where it is determined that the unlocking reference information and the unlocking request information are different through the comparison thereof is generated m more times or authentication failure information according to one or more other authentication schemes (for example, authentication scheme based on a PIN number input) is generated.

At this time, the controller 230 may also transmit position information of the first terminal 20. The position information may include Global Positioning System (GPS) position information, mobile communication service information (for example, base station information, a cell ID and the like) and the like.

When the management device of the communication service company receives the terminal security emergency message, the management device may transmit notification information related to the received terminal security emergency message by using contact information of the corresponding customer or control to limit a transmission function and/or a reception function of the first terminal 20.

The unlocking reference information the unlocking request information compared with the unlocking reference information stated in the specification may be one of motion information such as terminal inclination information obtained by a motion sensor of the first terminal 20, a face recognition information obtained by a camera, signature information such as signature written information, pattern information on a pattern connecting a plurality of points, Personal Identification Number (PIN) information, a password, biometric information (for example, finger print information, iris information and the like), image information and the like.

Hereinafter, the method of providing the terminal data security service by the first terminal 20 according to an embodiment of the present invention will be briefly described again.

FIG. 3 is a flowchart illustrating a method of providing a terminal data security service of the first terminal 20 according to an embodiment of the present invention.

Referring to FIG. 3, the method of providing the terminal data security service by the first terminal 20 includes step S310 of storing unlocking reference information (INF_REF) input to release the lock, step S330 of receiving unlocking request information (INF_REQ) input to release the lock in terminal state S320 corresponding to a locking state, step S340 of comparing the pre-stored unlocking reference information and the input unlocking request information, step S350 of changing the locking state to an unlocking state when it is determined that the pre-stored unlocking reference information and the input unlocking request information are the same as a result of the comparison, and step S360 of maintaining the locking state when it is determined that pre-stored unlocking reference information and the input unlocking request information are different.

In step S260, a count (initial value=0) which means a number of times by which it is determined that the pre-stored unlocking reference information and the input unlocking request information are different through the comparison therebetween is increased by 1.

After step S260, steps S370, S280, and S290 of performing security processes defined according to the count of generations of the case where it is determined that the pre-stored unlocking reference information and the input unlocking request information are different through the comparison in step S340 according to the repetitive input of the unlocking request information in step S330 may be further performed.

More specifically, after step S260, it is determined whether the count is larger than a pre-configured value of n in step S370.

As a result of the determination in step S270, when the count is not larger than the pre-configured value of n, that is, when the count is equal to or larger than 1 and equal to or smaller than n, a security process (for example, security process of inputting the unlocking request information again and outputting information on an instruction of a re-attempt of the unlocking) suitable for the determination result may be performed in step S380.

As a result of the determination in step S270, when the count is larger than the pre-configured value of n, a security process suitable for the determination result may be performed in step S390.

The security process in step S290 may be, for example, a security process of initializing the first terminal 20, a security process of outputting an alert message indicating that the first terminal 20 may be initialized if the case where it is determined that the unlocking reference information and the unlocking request information are different through the comparison therebetween is generated m more times, a security process of removing data stored in the first terminal 20, a security process of outputting an alert message indicating that the data stored in the first terminal 20 may be removed, or a security process of transmitting a terminal security emergency message to a management device of a communication service company of the first terminal 20.

According to the embodiment of the present invention, when the first terminal 20 is lost, a user who finds the lost first terminal 20 may repeatedly attempt to release the lock of the first terminal 20. When the attempt to release the lock is failed a predetermined number of times (n) or more, the security process may be used to provide the terminal security.

Accordingly, it is possible to prevent the data stored in the first terminal 20 to be leaked to the user who wants to illegally use the first terminal 20.

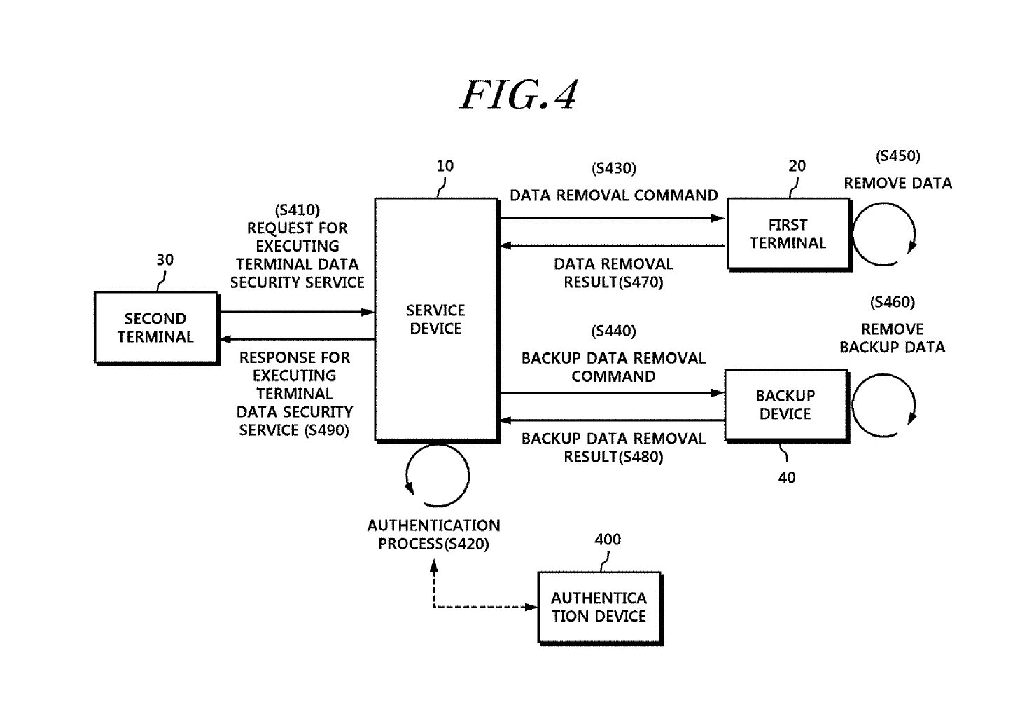

Next, a terminal data security service for data stored in an internal and/or external memory of the first terminal 20 through an interworking between the first terminal 20 and external another device will be described with reference to FIGS. 4 to 8.

The terminal data security service according to another embodiment of the present invention is a terminal data security service provided through an interworking between the first terminal 20 and another device.

The terminal data security service according to another embodiment off the present invention is a terminal data security service which removes the data stored in the first terminal 20 when a situation occurs in which, due to a particular reason, the user who desires to remove the data stored in the first terminal 20 does not possess the first terminal 20 in a state where the data stored in the first terminal 20 should be removed.

The data security service according to another embodiment of the present invention may be used as, for example, a service for preventing, when the user loses the first terminal 20, a risk that private data or data to be secured, stored in the lost first terminal 20 is leaked to another malicious user.

Further, in providing the terminal data security service according to another embodiment of the present invention, a security means which prevents other users from using or removing personal data stored in the first terminal 20 is also provided.

In addition, in providing the terminal data security service according to another embodiment of the present invention, when backup data of the data stored in the first terminal 20 is stored in the external backup device 40, the backup data stored in the backup device 40 may be also removed.

FIG. 4 illustrates a concept of a terminal data security service according to another embodiment of the present invention.

Referring to FIG. 4, the second terminal 30 transmits an execution request of a terminal Data Security Service (DSS) to the service device 10 in a state where data stored in the first terminal 20 should be removed in step S410.

Thereafter, the service server 10 performs an authentication process for an execution requester according to the terminal data security service execution request in step S420. At this time, the service server 10 may interwork with an authentication device 400.

As a result of the authentication process, when the authentication is succeeded, the service server 10 transmits a data removal command to the first terminal 20 in step S430.

At this time, the service server 10 may transmit a backup data removal command to the backup device 40 in step S440.

After steps S430 and S440, the first terminal 20 receives the data removal command and removes the corresponding data in step S450, and the backup device 40 receives the backup data removal command and removes the corresponding backup data in step S460.

Thereafter, the service device 10 receives a data removal result and a backup data removal result from the first terminal 20 and the backup device 40 in steps S470 and S480, and performs a response to the terminal data security service execution request in step S490.

Hereinafter, the terminal data security service according to another embodiment of the present invention having been briefly described above will be described in more detail in terms of the service device 10 and the first terminal 20.

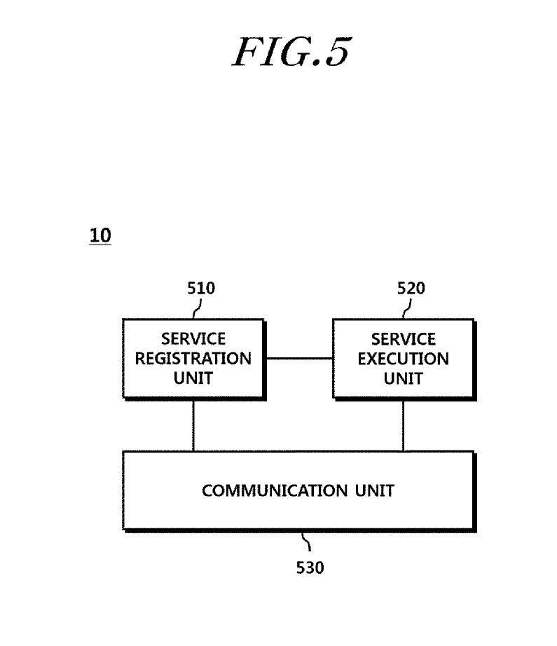

FIG. 5 is a block diagram of the service device 10 for the terminal data security service according to another embodiment of the present invention.

Referring to FIG. 5, the service device 10 for the terminal data security service according to another embodiment of the present invention includes a service execution unit 520 for transmitting a data removal command for removing data stored in an internal or an external storage device of the first terminal 20 according to an execution request of the terminal data security service, receiving a data removal result, and performing a response to the execution request according to the data removal result, and a communication unit 530 for communicating with the first terminal 20.

The service execution unit 520 receives an execution request of the terminal data security service including at least one of identification information of the first terminal 20, identification information of a owner of the first terminal 20 (for example, communication service subscriber) or a representative of the owner (for example, legal representative), and identification information of an execution requester of the terminal data security service from the second terminal 30.

The execution requester of the terminal data security service may be, for example, the owner of the first terminal 20 (for example, a communication service subscriber) or a representative of the owner (for example, legal representative).

Further, the second terminal 30 is a terminal related to an execution of the terminal data security service and may be a mobile terminal or a general PC.

Meanwhile, since the execution of the terminal data security service corresponds to removing personal data important to the owner of the first terminal 20 or private data (for example, contacts, pictures, finance related information, and personal information), an authentication of an execution requester who has made a request for executing the terminal data security service may be required.

Accordingly, the service execution unit 520 does not directly transmit a data removal command for executing the terminal data security service directly to the first terminal 20 according to the execution request of the terminal data security service, but performs an authentication process for the execution requester having made the request for executing the terminal data security service and determines whether to execute the terminal data security service according to an authentication result obtained through the authentication process.

That is, when the authentication result obtained through the authentication process corresponds to an authentication success, the service execution unit 520 may determine to execute the terminal data security service and transmit the data removal command to the first terminal 20 to actually execute the terminal data security service. When the authentication result obtained through the authentication process corresponds to an authentication failure, the service execution unit 520 transmits the authentication result corresponding to the authentication failure to the second terminal 30 having made the request for executing the terminal data security service.

The execution unit 520 may perform the authentication process for the execution requester based on authentication information included in the execution request of the terminal data security service received from the second terminal 30 or authentication information separately received.

The service execution unit 520 may obtain the authentication result by comparing the authentication information received from the second terminal 30 with authentication information stored in the first terminal and performing the authentication process or obtain the authentication result from an external authentication device having received the authentication result.

The service execution unit 520 may control to display an authentication information input window on the second terminal 30 according to the execution request for the terminal data security service and perform the authentication process based on authentication information input through the authentication information input window. At this time, in performing the authentication process based on the authentication information input through the authentication information input window displayed on the second terminal 30, the service execution unit 520 may perform the authentication process by interworking with a separate authentication device (for example, an authority server) located outside.

The authentication information input window may be an authentication information input window corresponding to an authentication scheme selected by a registration requester in a service registration process described below. Further, the authentication information is authentication information corresponding to an authentication scheme selected by the registration requester in the service registration process described below, and may include, for example, various passwords, an accredited certificate password, a One Time Password (OTP), an Internet Personal Identification Number (I-PIN) and the like.

Meanwhile, since the execution of the terminal data security service corresponds to removing personal data important to the owner of the first terminal 20 or private data (for example, contacts, pictures, finance related information, and personal information), it is required to make the execution request for the terminal data security service and perform an actual execution only in a state where the owner of the first terminal 20 or a representative (for example, legal representative such as parents) of the owner has registered the terminal data security service in an additional service type.

Accordingly, the service device 10 for the terminal data security service according to another embodiment of the present invention may further include a service registration unit 510 for transmitting the data removal command for removing the data stored in the internal or external storage device of the first terminal 20 to the first terminal 20 according to a registration request for the terminal data security service and storing and managing registration information of the terminal data security service for executing the terminal data security service.

Meanwhile, since the execution of the terminal data security service corresponds to removing personal data important to the owner of the first terminal 20 or private data (for example, contacts, pictures, finance related information, and personal information), an authentication process for a registration requester is required to prevent other users from registering the terminal data security service.

Accordingly, the service registration unit 510 may perform the authentication process for the registration requester who has made the registration request for the terminal data security service according to the registration request for the terminal data security service by the registration requester and determine whether to register the terminal data security service according to an authentication result obtained through the authentication process.

In storing registration information of the terminal data security service, the service registration unit 510 may also store type information of an authentication scheme selected by the registration requester for the authentication process to be performed according to the execution request for the terminal data security service. The type information of the authentication scheme may be type information for identifying one of an accredited certificate based authentication scheme, an OTP based authentication scheme, a password based authentication scheme, and an I-PIN based authentication scheme. When the execution request for the terminal data security service is received, the type information of the authentication scheme corresponds to a designation of the authentication scheme of the authentication process performed for authenticating the execution requester before an actual execution of the terminal data security service.

Further, in storing registration information of the terminal data security service, the service registration unit 510 may also store one or more of identification information of the first terminal 20, identification information of the owner of the first terminal 20 or the representative of the owner, and identification information of the registration requester of the terminal data security service.

Accordingly, it is possible to designate a terminal, which stores data, to be removed, to designate a user who possesses a terminal storing data to be removed, or to record a registration requester having made a request for registering the terminal data security service.

Further, in storing the registration information of the terminal data security service, the service registration unit 510 may also store identification information of an execution requester which can make the execution request for the terminal data security service.

As described above, the user who can make the execution request for the terminal data security service in the future is designated when the terminal data security service is registered, so that the data stored in the first terminal 20 cannot be removed by anybody.

That is, when the execution request for the terminal data security service is received, the service execution unit 520 may identify identification information of the execution requester who has been stored when the terminal data security service is registered and identify whether the user having made the execution request is a user who is allowed to make the execution request, so as to determine whether to execute the terminal data security service.

Further, in storing registration information of the terminal data security service, the service registration unit 510 may also store identification information of the second terminal 30 which can make the execution request for the terminal data security service.

This is to prevent the execution request for the terminal data security service from being made anywhere. That is, when the execution request for the terminal data security service is received, the service execution unit 520 may identify identification information of the second terminal 30 which has been stored when the terminal data security service is registered and identify whether the terminal having made the execution request is a terminal which is allowed to make the execution request, so as to determine whether to execute the terminal data security service.

Meanwhile, nowadays a service that backs up data stored in a mobile terminal such as a smart phone, a tablet PC, or the like onto an external another device (server) is widely used. For example, a backup service includes a cloud service which backs up and stores user data stored in a mobile terminal such as a media file including a movie, a picture, a music and the like, a document, an address book and the like in a server online and downloads the user data to any device when needed.

The backup service is widely provided by an Internet portal. Further, nowadays a backup function which backs up data stored in a mobile terminal such as a smart phone, a tablet PC or the like onto an external device is basically provided.

Accordingly, it is required to remove backup data of some or all of the data stored in the internal or external storage device of the first terminal 20 which may be a mobile terminal such as a smart phone, a tablet PC or the like as well as the data store in the internal or external storage device.

In storing the registration information of the terminal data security service when the terminal data security service is registered, the service registration unit 510 may also store backup data removal control information for removing the backup data backed up onto one or more backup devices 40 inside or outside the service device 10.

The backup device 40 may be, for example, a cloud server for a cloud service, a server for user data backup operated by an Internet portal and the like.

Further, the backup data removal control information may include, for example, information for identifying one or more backup devices 40 inside or outside the service device 10 or information for proving that the backup device 40 is allowed to remove the corresponding backup data.

As described above, when the backup data removal is also registered when the terminal data security service is registered, that is, when backup data removal control information corresponding to the registration information of the terminal data security service is stored, if the service execution unit 520 receives the execution request for the terminal data security service in the future, the service execution unit 520 may transmit a backup data removal command to the one or more backup devices 40 by using the backup data removal control information separately transmitting a data removal command to the first terminal 20, receive a backup data removal result, and perform a response to the execution request according to the backup data removal result and a data removal result.

Meanwhile, although the service execution unit 520 receives the execution request for the terminal data security service from the second terminal 30 and transmits the data removal command to the first terminal 20, the first terminal may be in a state where power is turned off, a state where communication is not possible, or a state where the data removal command cannot be received.

Accordingly, in order to increase a probability that the first terminal 20 receives the data removal command, the service execution unit 250 may transmit the data removal command to the first terminal 20 n or more times before receiving the data removal result. The number of transmissions n may be a value configured by the system, a variable value which can be configured in accordance with a data importance level, or a value configured by the execution requester.

Further, the service execution unit 520 may configure a time and a period on which the data removal command is transmitted and transmit the data removal command according to the configured time and period.

In addition, the service execution unit 520 may monitor whether the first terminal 20 is in a state where communication with a communication service network is possible. When the communication is possible, the service execution unit 520 may transmit the data removal command to the first terminal 20.

That is, when power of the first terminal 20 is turned off or a communication function of the first terminal 20 is deactivated, the service execution unit 520 cannot transmit the data removal command to the first terminal 20.

When a user who finds the first terminal 20 turns on the power of the first terminal 20 even for a while, the communication function of the first terminal 20 is activated, and the service execution unit 520 monitors a communication available state of the first terminal 20 and immediately transmits the data removal command to the first terminal 20.

In this case, the service execution unit 520 receives, for example, state information indicating that the first terminal 20 can communicate with the communication service network from the communication service network, so that the service execution unit 520 may recognize that the first terminal 20 is in the communication available state with the communication service network and immediately transmit the data removal command to the first terminal 20.

Alternatively, when the execution request for the terminal data security service is received, the service execution unit 520 records information indicating that the execution request for the terminal data security service is generated in a predetermined device within the communication service network, so that the first terminal 20 may identify the recorded information to make a request for transmitting the data removal command to the service device 10 or remove the data by itself.

That is, when the first terminal 20 which is aware of the terminal data security service registration state enters the communication available state with the communication service network, the first terminal 10 recognizes that the execution request for the terminal data security service is generated through the communication service network. Then, the first terminal 20 makes a request for transmitting the data removal command to the service server 10 and receives the data removal command, so as to remove the data, or may immediately remove the data without any request for transmitting the data removal command.

The data removal command described in the specification is a command which the service device 10 transmits to the first terminal 20 to remove the data stored in the first terminal 20.

The data removal command may be, for example, a command for removing all user data (for example, data generated by the user, such as an address book, a picture, music, a document and the like) stored in the internal or external storage device of the first terminal 20.

Further, the data removal command may be a command for formatting a memory which is the internal storage device of the first terminal 20.

In addition, the data removal command may be a command for removing data (for example, including user data, an application and the like) stored in the internal or external storage device (for example, external memory such as an SD card, a Universal IC Card (UICC) or the like) of the first terminal 20. The UICC may be a Universal Subscriber Identity Module (USIM) card, a Subscriber Identity Module (SIM) card or the like.

Meanwhile, when the execution request for the terminal data security service is received, the service execution unit 520 may control to stop a call originating function of the first terminal 20, transmit the data removal command to the first terminal 20, and then receive a data removal result in a message form from the first terminal 20 of which the call originating function has been stopped.

Even though the call originating function of the first terminal 20 is stopped, the service execution unit 520 controls to maintain a function for transmitting/receiving the data removal command and the data removal result.

The aforementioned message form may be a form of a message which the user cannot recognize, for example, an emergency call message, a control message, or a system message.

Hereinafter, the first terminal 20 interworking with the service device 10 of FIG. 5 in connection with the provision of the terminal data security service according to another embodiment of the present invention will be described.

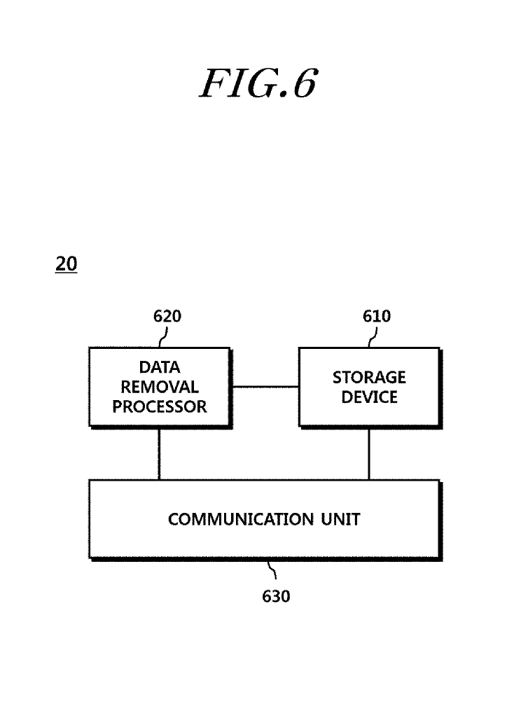

FIG. 6 is a block diagram of the terminal 20 for the terminal data security service according to another embodiment of the present invention.

Referring to FIG. 6, the terminal 20 for the terminal data security service according to another embodiment of the present invention includes an internal or external storage device 610 for storing data, a data removal processor 620 for, when receiving a data removal command for removing the data stored in the internal or external storage device 610 from the service device 10, performing a data removal process for the internal or external storage device 610 to transmit a data removal result to the service device 10, and a communication unit 630 for communicating with the service device 10.

When the data removal processor 620 identifies information indicating that the execution request for the terminal data security service has been generated (there is the execution request for the terminal data security service) from a communication service network in a state where the data removal processor 620 has not received the data removal command, the data removal processor 620 may transmit a request for transmitting the data removal command to the service device 10. Then, when the data removal processor 620 receives the data removal command, the data removal processor 620 may perform the data removal process to remove the corresponding data.

Further, when the data removal processor 620 identifies information indicating that the execution request for the terminal data security service has been generated (there is the execution request for the terminal data security service) from the communication service network in the state where the data removal processor 620 has not received the data removal command, the data removal processor 620 may perform the data removal process by itself immediately or after a predetermined time to remove the corresponding data without transmitting the request for transmitting the data removal command.

The data removal processor 620 stores the data removal result generated by performing the data removal process by itself. When the data removal processor 620 identifies a state where communication with the service device 10 is possible, the data removal processor 620 may transmit the stored data removal result to the service device 10.

The internal or external storage device 610 described in the specification may be, for example, a memory installed within the terminal, an external memory or a UICC (USIM card or SIM card) removably installed in the terminal 20, or a UICC (USIM card or SIM card) installed within the terminal 20.

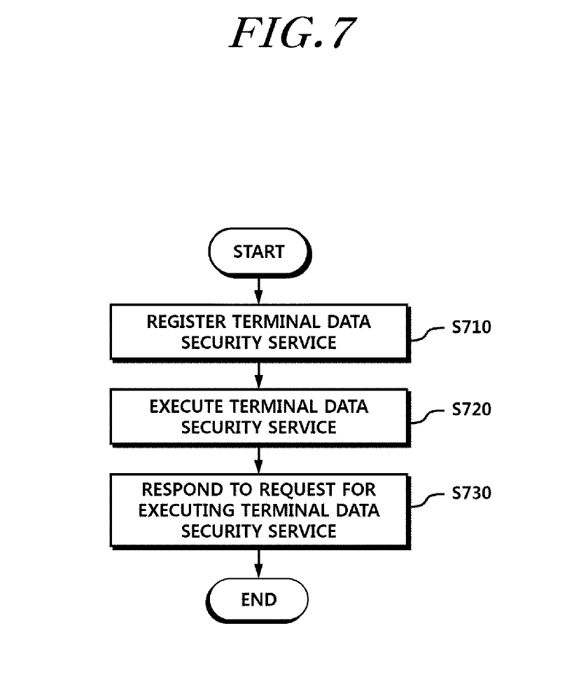

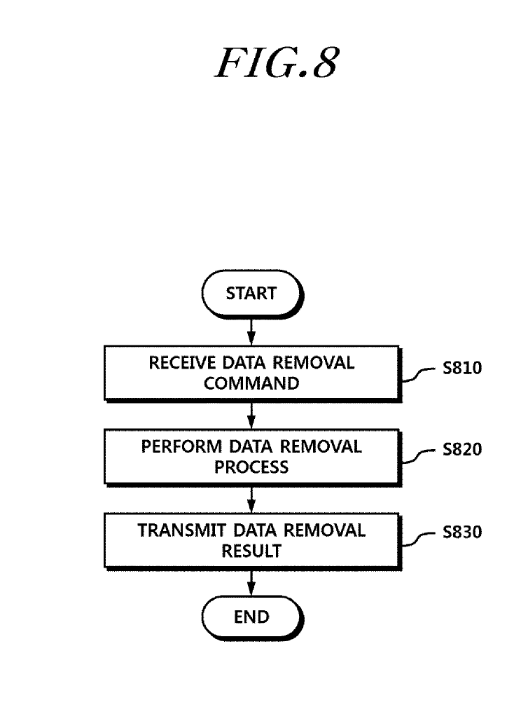

Hereinafter, the terminal data security service method provided by each of the service device 10 and the terminal 20 according to another embodiment of the present invention will be briefly described again with reference to FIGS. 7 and 8.

FIG. 7 is a flowchart illustrating the terminal data security service method of the service device 10 according to another embodiment of the present invention.

Referring to FIG. 7, the terminal data security service method of the service device 10 according to another embodiment of the present invention includes step S720 of transmitting a data removal command for removing data stored in the internal or external storage unit 610 of the first terminal 20 to the first terminal 20 according to an exertion request for the terminal data security service and step S730 of, after the transmission of the data removal command, receiving a data removal result generated by performing a data removal process from the first terminal 20 and processing a response to the execution request according to the data removal result.

Before step S720 of executing the terminal data security service, step S710 of registering and managing registration information of the terminal data security service for executing the terminal data security service by transmitting the data removal command for removing the data stored in the internal or external storage device 610 of the first terminal 20 to the first terminal 20 according to a registration request for the terminal data security service may be further performed.

FIG. 8 is a flowchart illustrating the terminal data security service method of the terminal 20 according to another embodiment of the present invention.

Referring to FIG. 8, the terminal data security service method of the terminal 20 according to another embodiment of the present invention includes step S810 of receiving a data removal command for removing data stored in the internal or external storage device 610 from the service device 10 and step S820 of performing a data removal process for the internal or external storage device 610, and step S830 of transmitting a data removal result according to the data removal process to the service device 10.

According to another embodiment of the present invention described above, even when the user who desires to remove data stored in the first terminal 20 does not possess the terminal in a state where the data stored in the first terminal 20 should be removed due to a particular reason, the embodiment of the present invention allows the user to remove the data stored in the internal or external storage device of the first terminal 20, thereby preventing personal and private data to be leaked to the outside.

A backup data security service according to another embodiment of the present invention is a data security service for backup data generated by backing up the data stored in the first terminal 20 onto the backup device 40.

The backup data security service according to another embodiment of the present invention is a service which allows the user to remove the backup data of the data stored in the first terminal 20 even though the user who desires to remove the backup data stored in the backup device 40 does not possess the first terminal 20 in a state where the backup data of the data stored in the first terminal 20 should be removed due to a particular reason.

The data stored in the first terminal 20 related to the backup data security service according to another embodiment of the present invention may be pre-designated and stored, stored in a predetermined position, or stored in a pre-designated file format.

In connection with this, designating backup data to be removed, a position to be removed, or a file format to be removed may be made according to a configuration by the user when the backup data security service is registered.

The backup data security service according to another embodiment of the present invention may be used as, for example, a service for preventing, when the user loses the first terminal 20, a risk that personal data or backup data stored in the lost first terminal 20 is leaked to another malicious user.

Further, when the backup data security service according to another embodiment of the present invention is provided, a security means for preventing anybody from using or removing the backup data is also provided.

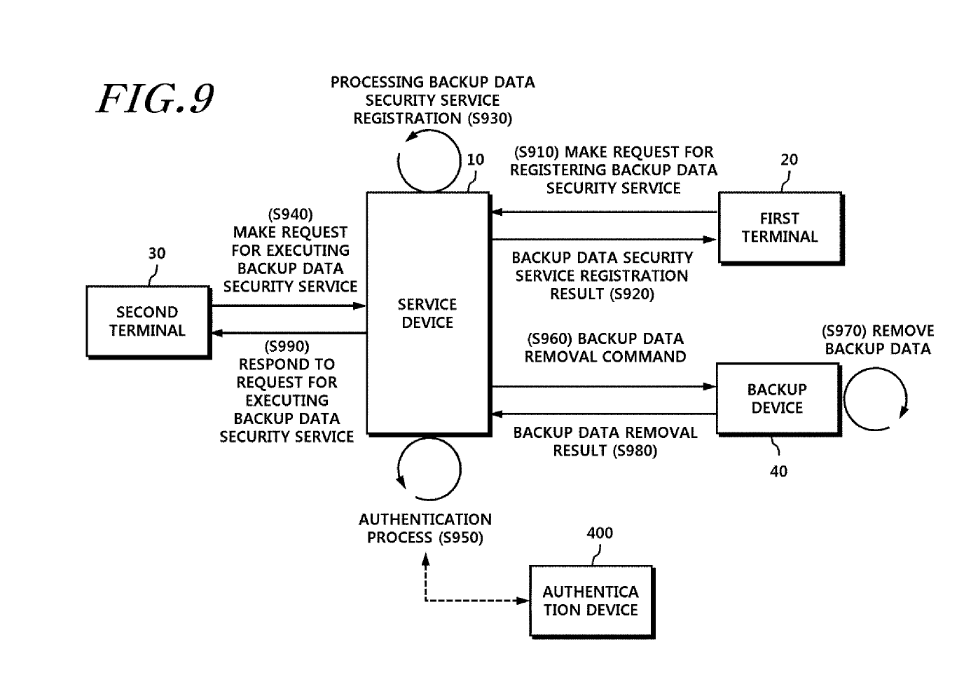

FIG. 9 illustrates a concept of the backup data security service according to another embodiment of the present invention.

Referring to FIG. 9, the first terminal 20 transmits a registration request for the backup data security service to the service device 10 in step S910 and performs registration processing of the backup data security service for the corresponding first terminal 20 or the corresponding user and transmits a result thereof to the first terminal 20 in step S920. At this time, the service device 10 may interwork with the backup device 40 in the registration processing of the backup data security service.

Thereafter, when a situation where the user (execution requester) should remove the backup data is generated, an execution request for the backup data security service is transmitted to the service device 10 through the second terminal 30 in step S940.

The service device 10 performs an authentication process for the execution requester in step S950. At this time, the service server 10 may interwork with an authentication device 200.

When the authentication is succeeded, the service device 10 transmits a backup data removal command to the backup device 40 in step S960.

The backup device 40 extracts and removes the corresponding backup data according to the backup data removal command received from the service device 10 in step S970 and transmits a result thereof to the service device 10 in step S980.

The backup data removal command may include, for example, terminal identification information, backup data identification information, and proof information on the removal of the backup data.

The service device 10 responds to the execution request for the backup data security service according to the backup data removal result received from the backup device 40.

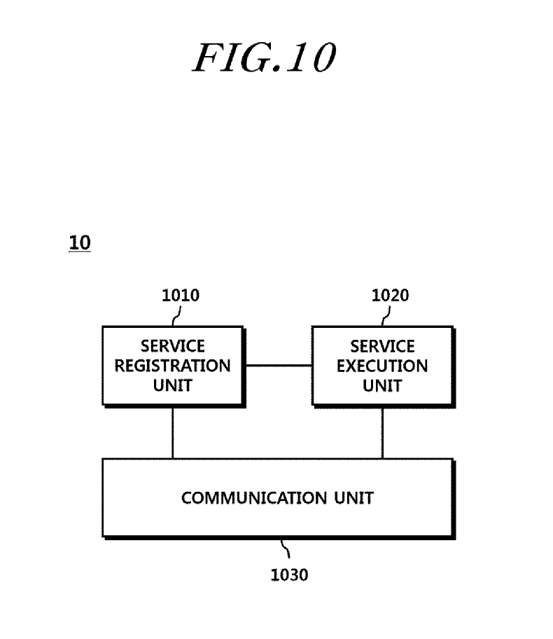

FIG. 10 is a block diagram of the service device 10 according to another embodiment of the present invention.

Referring to FIG. 10, the service device 10 according to another embodiment of the present invention includes a service execution unit 1020 for transmitting a backup data removal command for removing backup data of the data stored in the internal or external storage device of the first terminal 20 from the backup device 40 to the backup device 40 according to the execution request for the backup data security service, receiving a backup data removal result, and processing a response to the execution request, and a communication unit 1030 for communicating with the backup device 40.

The data stored in the internal or external storage device of the first terminal 20 is original data of the backup data and may be all or some of the data stored in the internal or external device of the first terminal 20. When the backup data corresponds to some of the data, the original data of the removed backup data among the data stored in the internal or external storage device may be data in a predetermined file format or data stored in a predetermined position (or folder).

The service execution unit 1020 may receive the execution request for the backup data security service including one or more of identification information of the first terminal 20 storing the original data of the backup data, identification information of an owner of the first terminal 20 or a representative (for example, legal representative) of the owner, identification of an execution requester (may be the same person as the owner or the representative) of the backup data security service, and information related to an access to the backup device 40.

Meanwhile, the service execution unit 1020 may perform an authentication process for the execution requester who has made the execution request for the backup data security service according to the execution request for the backup data security service and determine whether to execute the backup data security service according to an authentication result obtained through the authentication process.

The service execution unit 1020 may perform the authentication process for the execution requester who has made the execution request for the backup data security service by using an input password and a password stored inside or outside the service device 10 according to the execution request for the backup data security service and determine whether to execute the backup data security service according to the authentication result obtained through the authentication process.

When the authentication result obtained through the authentication process corresponds to a success, the service execution unit 1020 may determine to execute the backup data security service and transmit a backup data removal command to the backup device 40.

In connection with authentication information, the service execution unit 1020 may perform the authentication process based on authentication information included in the execution request for the backup data security service or separately received authentication information.

For example, the service execution unit 1020 may control to display an authentication information input window on the second terminal 30 according to the execution request for the backup data security service and receive authentication information input through the authentication information input window.

Further, the service execution unit 1020 may obtain the authentication result by comparing the authentication information included in the execution request for the backup data security service or the separately received authentication information with the authentication information stored inside to perform the authentication process or obtain the authentication result from the authentication device 200 after the separately received authentication information is transmitted to the external authentication device 200.

Meanwhile, the service device 10 according to another embodiment of the present invention may further include a service registration unit 1010 for transmitting a backup data removal command for removing backup data of the data stored in the internal or external storage device of the first terminal 20 to the backup device 40 according to a registration request for the backup data security service and storing and managing registration information of the backup data security service for executing the backup data security service.

In storing the registration information of the backup data security service, the service registration unit 1010 may further store authentication information as reference information compared with the authentication information in the authentication process to determine whether to execute the backup data security service when the execution request for the backup data security service is generated in the future.

Further, the service registration unit 1010 may perform the authentication process for the registration requester who has made the registration request for the backup data security service according to the registration request for the backup data security service and determine whether to register the backup data security service according to an authentication result obtained through the authentication process. The registration requester may be an owner of the first terminal 20 or a representative of the owner, or the same person as the execution requester who has made the execution request for the backup data security service.

Further, in storing the registration information of the backup data security service, the service registration unit 1010 may also store backup data removal control information for removing the backup data backed up onto the backup device 40.

The backup data removal control information may include, for example, information for identifying the backup device 40 and information for proving that the backup device 40 is allowed to remove the corresponding backup data.

Further, the backup data removal control information may include information on a login ID and password of the corresponding user in a backup service site corresponding to the backup device 40.

In storing the registration information of the backup data security service, the service registration unit 1010 may also store one or more of identification information of the first terminal 20, identification information of the owner of the first terminal 20 or the representative of the owner, and identification information of the execution requester of the backup data security service.

Further, in storing the registration information of the backup data security service, the service registration unit 1010 may also store identification information of the execution requester which can make the execution request for the backup data security service.

In addition, in storing the registration information of the backup data security service, the service registration unit 1010 may also store identification information of the second terminal 30 which can make the execution request for the backup data security service.

In order to increase a success rate of the backup data removal, the service execution unit 1020 may transmit the backup data removal command to the backup device 40 n or more times before receiving the backup data removal result from the backup device 40.

Further, in order to increase the success rate of the backup data removal, the service execution unit 1020 may check whether the communication with the backup device 40 is possible. When the communication is possible, the service execution unit 102 may transmit the backup data removal command to the backup device 40.

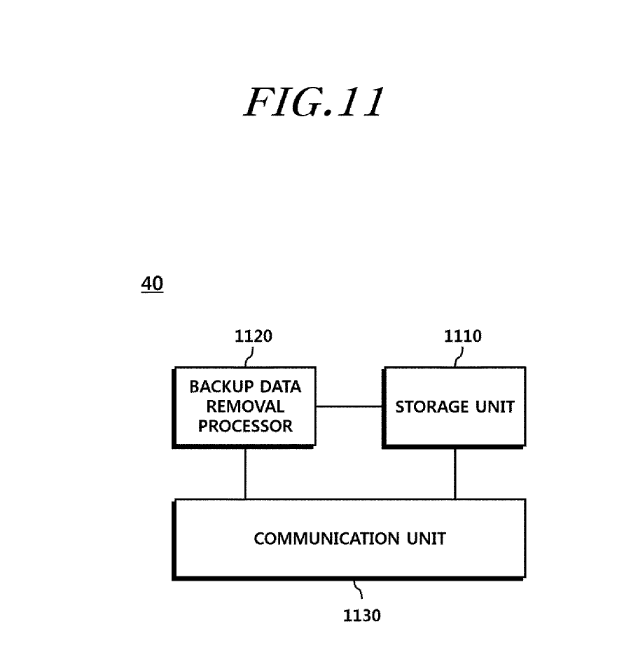

FIG. 11 is a block diagram of the backup device 40 according to another embodiment of the present invention.

Referring to FIG. 11, the backup device 40 according to another embodiment of the present invention includes a storage unit 1110 for storing backup data generated by backing up the data (original data) stored in the internal or external storage device of the first terminal 20, a backup data removal process 1120 for, when receiving a backup data removal command of the backup data from the service device 10, performing a backup data removal process for the backup data stored in the storage unit 1110 and transmitting a backup data removal result to the service device 10, and a communication unit 1130 for communicating with the service device 10.

The backup device 40 may be, for example, a cloud server for a cloud service, a server for the backup operated by an Internet portal, a terminal OS developer, or a terminal manufacturer.

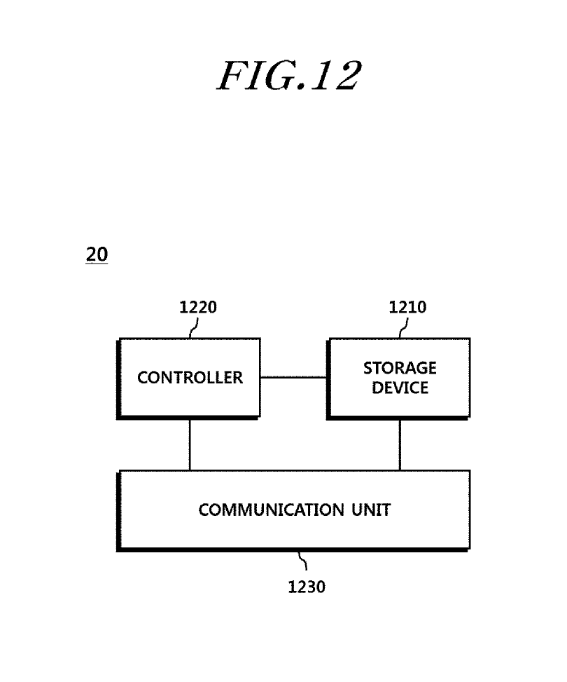

FIG. 12 is a block diagram of the first terminal 20 according to another embodiment of the present invention.

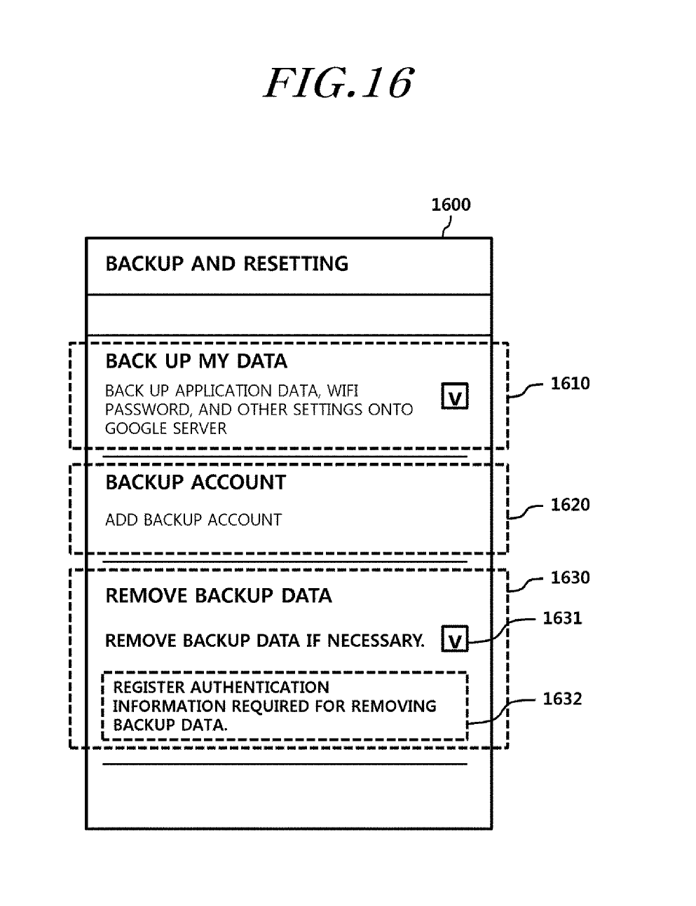

Referring to FIG. 12, the first terminal 20 according to another embodiment of the present invention includes an internal or external storage device 1210 for storing data, a controller 1220 for providing an interface (see FIG. 16) that registers the backup data security service for removing the backup data of the data (original data) stored in the internal or external storage device, backed up onto the backup device 40 in the service device 10, and a communication unit 1230 for communicating with the service device 10.

The controller 1220 may receive authentication information through the interface that registers the backup data security service and registers the input authentication information in the service device 10 or the backup device 40.

At this time, when the execution request for the backup data security service is generated in the service device 10 in the future, the received authentication information may be reference information to be compared with the authentication information input when the authentication process is performed in the service device 10 before the backup data security service is actually performed.

The first terminal 20 illustrated in FIG. 12 may be a mobile terminal, for example, a smart phone, a tablet PC, a Personal Digital Assistant (PDA), and a mobile communication terminal.

Further, an internal or external storage device 1210 of the first terminal 20 may be a memory installed within the first terminal 20, an external memory or a UICC (USIM card or SIM card) removably installed in the first terminal 20, or a UICC (USIM card or SIM card) installed within the first terminal 20.

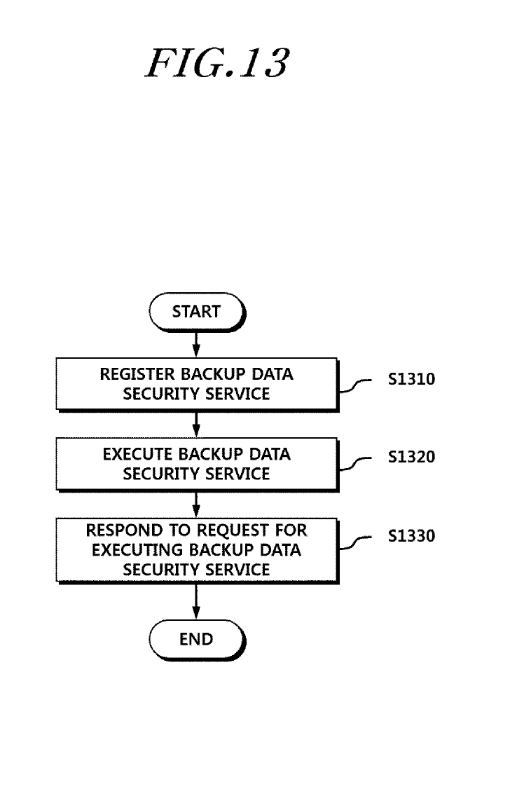

The backup data security service method according to another embodiment of the present invention described for each of the devices 10, 40, and 20 will be briefly described again with reference to FIGS. 13, 14, and 15.

FIG. 13 is a flowchart illustrating the backup data security service method of the service device 10 according to another embodiment of the present invention.

Referring to FIG. 13, the backup data security service method of the service device 10 according to another embodiment of the present invention includes step S1320 of transmitting a backup data removal command for removing backup data of the data stored in the internal or external storage device 1210 of the first terminal 20 from the backup device 40 to the backup device 40 according to an execution request for the backup data security service and step S1330 of, after the transmission of the backup data removal command, receiving a backup data removal result and processing a response to the execution request.

Further, as illustrated in FIG. 13, the backup data security service method of the service device 10 according to another embodiment of the present invention may further include step S1310 of storing and managing registration information of the backup data security service for executing the backup data security service by transmitting the backup data removal command for removing the backup data of the data stored in the internal or external storage device 1210 of the first terminal 20 from the backup device 40 to the backup device 40 according to a registration request for the backup data security service.

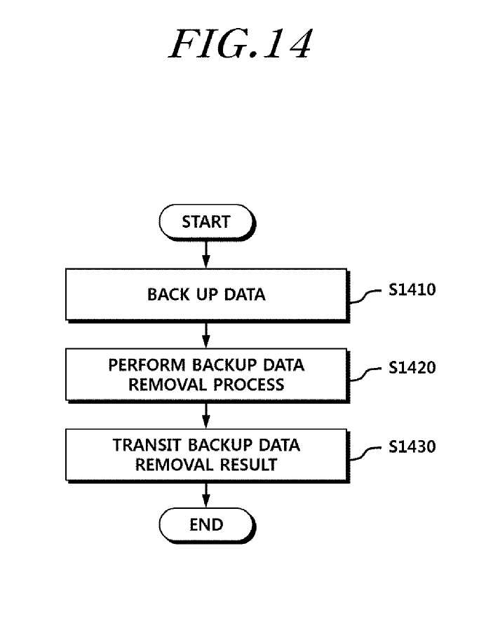

FIG. 14 is a flowchart illustrating the backup data security service method of the backup device 40 according to another embodiment of the present invention.

Referring to FIG. 14, the backup data security service method of the backup device 40 according to another embodiment of the present invention includes step S1410 of storing the backup data backed up from the data stored in the internal or external storage device 1210 of the first terminal 20, step S1420 of, when receiving a backup data removal command of the backup data from the service device 10, performing a backup data removal process for the backup data, and step S1430 of transmitting a backup data removal result according to the backup data removal process to the service device 10.

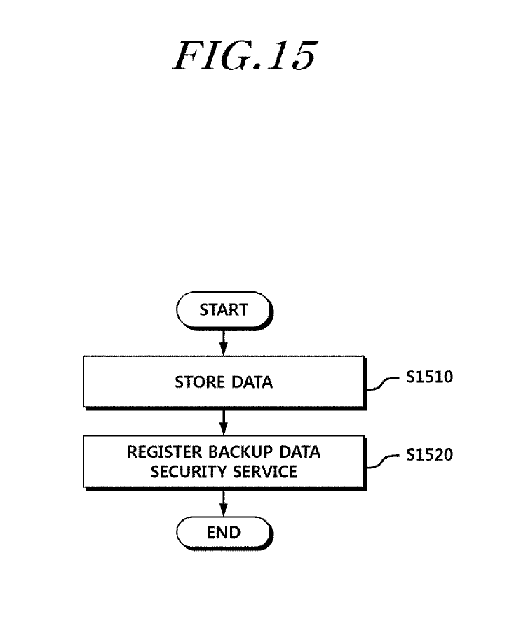

FIG. 15 is a flowchart illustrating the backup data security service method of the first terminal 20 according to another embodiment of the present invention.

Referring to FIG. 15, the backup data security service method of the first terminal 20 according to another embodiment of the present invention includes step S1510 in which the internal or external storage device 1210 stores data and step S1520 in which the controller 1220 provides an interface that registers, in the service device 10, the backup data security service for removing the backup data of the data stored in the internal or external storage device 1210, backed up onto the backup data 40.

FIG. 16 illustrates an example of a screen 1600 of an interface provided by the first terminal 20 to register the backup data security service according to another embodiment of the present invention.

Referring to FIG. 16, the screen 1600 of the first terminal 20 includes a backup service configuration part 1610 displaying an interface that configures the backup service to back up the data (for example, application data, WiFi password, other configurations and the like) stored in the internal or external storage device 1210 onto the backup device 40 (for example, Google server) and a backup data security service registration part 1630 displaying an interface that may register the backup data security service to remove the backup data backed up onto the backup device 40 when the backup service is configured through the backup service configuration unit 1610.

Referring to FIG. 16, the user may register the backup data security service by checking a box 1631 in the backup data security service registration part 160. Further, the user may register the backup data security service by inputting authentication information to be used in the authentication process when the backup data security service is executed.

As described above, according to another embodiment of the present invention, when the user desires to remove the backup data in a state where the user recognizes or does not recognize the existence of the backup data, the backup data backed up from the data stored in the terminal (first terminal 20) can be removed through only a simple control.

The processes of the data security service method according to the embodiments of the present invention may be changed, or two or more thereof may be combined, or one process may be divided into two or more steps without departing from the essential concept of the present invention.

The method of providing the data security service of the first terminal 20 according to embodiments of the present invention may be executed by an application basically installed in the first terminal 20 by default (it may be a program included in a platform basically installed in the terminal, included in an OS, or compatible with the OS), and also may be compatible with an OS of the terminal 20 through an application providing server such as an application store server or a web server related to an application or the corresponding service and executed by an application (that is, program) directly installed in the terminal 20. The OS of the terminal 20 may be Windows installed in a general PC such as a desktop PC, Macintosh, or a mobile dedicated OS such as iOS or Android installed in a mobile terminal such as a smart phone, a tablet PC or the like.

In this context, the method of providing the data security service of the first terminal 20 according to embodiments of the present invention may be implemented by an application (that is, program) installed in the first terminal 20 by default or installed directly by the user and may be recorded in a computer-readable recording medium such as the first terminal 20.

The program implementing the method of providing the data security service of the first terminal 20 according to embodiments of the present invention may perform a function of comparing pre-stored unlocking reference information and currently input unlocking request information and a function of performing a security process defined according to a count of the cases where it is determined that the unlocking reference information and the unlocking request information are different through the comparison therebetween.

Further, the program implementing the method of providing the data security service of the first terminal 20 according to embodiments of the present invention may perform a function of receiving a data removal command for removing data stored in the internal or external storage device 610 of the first 20 from the service device 10, a function of performing a data removal process for the internal or external storage device 610, and a function of transmitting a data removal result according to the data removal process to the service device 10.

In addition, the program implementing the method of providing the data security service of the first terminal 20 according to embodiments of the present invention may perform a function in which the internal or external device 1210 stores data and a function in which the controller 1220 provides an interface that registers, in the service device 10, the backup data security service for removing the backup data of the data stored in the internal or external storage device 1210, backed up onto the backup device 40.

The program may be recorded in a computer-readable recording medium and implemented by a computer, so as to implement the above described functions.

As described above, to enable the computer to read a program recorded in the recording medium by a computer and to implement the a security function providing method according to an embodiment of the present invention embodied by the program, the program may include a code that is coded into a computer language such as C, C++, JAVA, a machine language, and the like which is readable by a processor (CPU) of the computer.

The code may include a function code associated with a function that defines the described functions and the like, and may include an implementation process control code that may be required for the processor of the computer to implement the described functions based on a predetermined process.

Also, the code may further include a memory reference code indicating a location (address number) of an internal or external memory of the computer where the processor of the computer may refer to additional information or media required to implement the described functions.

Also, when the processor of the computer needs to communicate with another computer, a server, or the like placed in a remote location for implementing the described functions, the code may further include a communication code indicating a communication method of how to communicate with the other computer, the server, or the like placed in the remote location using a communication module (for example, a wired and/or wireless communication module) of the computer, information or media to be transmitted or received during the communication, and the like.

Functional programs for implementing the present invention, codes and code segments associated with the same, and the like may be readily inferred or modified by programmers skilled in the art of the present invention by taking into consideration a system environment of the computer that reads a recording medium and implements a program, and the like.

Further, the computer-readable recording medium is distributed to a computer system connected to the network, and thus may store and execute a computer-readable code in a distribution manner. In this case, one or more of a plurality of distributed computers may execute a part of the above listed functions and transmit a result of the execution to one or more of other distributed computers. Then, the computers having received the result may also execute a part of the functions and provide a result of the execution to other distributed computers.

As described above, the computer-readable recording medium recording the program for performing the method of providing the data security service of the first terminal 20 according to embodiments of the present invention may include, for example, a Read Only Memory (ROM), a Random Access Memory (RAM), a Compact disk (CD)-ROM, a magnetic tape, a floppy disk, an optical media storage device and the like.

Further, the computer-readable recording medium recording an application which is the program for performing the method of providing the data security service of the first terminal 20 according to embodiments of the present invention may be a recording medium (for example, hard disk) included in an application provider server including an application store server or a web server related to an application or a corresponding service, the application provider server itself, another computer recording to the program, or a storage medium.

The computer which can read the recording medium recording the application which is the program for performing the method of providing the data security service of the first terminal 20 according to embodiments of the present invention should be construed as not only a general PC such as a general desktop or a notebook, and a mobile terminal such as a smart phone, a tablet PC, a PDA, or a mobile communication terminal but also all devices which can perform a computing function.

When the computer which can read the recording medium recording the application which is the program for performing the method of providing the data security service of the first terminal 20 according to embodiments of the present invention is a mobile terminal such as a smart phone, a tablet PC, a PDA, or a mobile communication terminal, the mobile terminal may download a corresponding application from the application provider server including the application store server and the web server and install the downloaded application. In some cases, the application is downloaded from the application provider server to a general PC and then installed in the mobile terminal through a synchronization program.

Even if it was described above that all of the components of an embodiment of the present invention are coupled as a single unit or coupled to be operated as a single unit, the present invention is not necessarily limited to such an embodiment. At least two elements of all structural elements may be selectively joined and operate without departing from the scope of the present invention.

In addition, although each of the components may be implemented as an independent hardware, some or all of the components may be selectively combined with each other, so that they can be implemented as a computer program having one or more program modules for executing some or all of the functions combined in one or more pieces of hardware.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. A term ordinarily used like that defined by a dictionary shall be construed that it has a meaning equal to that in the context of a related description, and shall not be construed in an ideal or excessively formal meaning unless it is clearly defined in the present specification.

Although the embodiments of the present invention have been described for illustrative purposes, those skilled in the art will appreciate that various modifications, additions and substitutions are possible, without departing from the scope and spirit of the invention. Therefore, exemplary embodiments of the present disclosure have been described for the sake of brevity and clarity. The scope of the present invention shall be construed on the basis of the accompanying claims in such a manner that all of the technical ideas included within the scope equivalent to the claims belong to the present invention.

What is claimed is:

1. A terminal providing a data security service, the terminal comprising:
a storage unit for storing unlocking reference information input for unlocking;
an input unit for receiving unlocking request information for the unlocking in a locking state; and
a controller for comparing the unlocking reference information and the unlocking request information, changing the locking state to an unlocking state when it is determined that the unlocking reference information and the unlocking request information are identical, and maintaining the locking state when it is determined that the unlocking reference information and the unlocking request information are different,
wherein the controller performs a security process defined according to a count of cases where it is determined that the unlocking reference information and the unlocking request information are different through the comparison therebetween.

2. The terminal of claim 1, wherein, when the count of the cases where it is determined that the unlocking reference information and the unlocking request information are different through the comparison therebetween is equal to or larger than 1 and equal to or smaller than n, the controller performs a security process for outputting information indicating a re-attempt of the unlocking through a re-input of the unlocking request information.

3. The terminal of claim 1, wherein, after the count of the cases where it is determined that the unlocking reference information and the unlocking request information are different through the comparison therebetween exceeds n, the controller performs a security process for initializing the terminal or a security process for outputting an alert message indicating that the terminal may be initialized, or performs the security process for initializing the terminal or the security process for outputting the alert message indicating that the terminal may be initialized if the case where it is determined that the unlocking reference information and the unlocking request information are different through the comparison therebetween is generated m more times according to an additional input of the unlocking request information or authentication failure information according to at least one other authentication scheme is generated.

4. The terminal of claim 3, wherein, after performing the security process for initializing the terminal, the controller controls to maintain a configuration state for an unlocking type before the initialization of the terminal and maintain and store the unlocking reference information even after the initialization of the terminal.

5. The terminal of claim 1, wherein, after the count of the cases where it is determined that the unlocking reference information and the unlocking request information are different through the comparison therebetween exceeds n, the controller performs a security process for removing data stored in the terminal or a security process for outputting an alert message indicating that the data stored in the terminal may be removed, or performs the security process for removing the data stored in the terminal or the security process for outputting the alert message indicating that the data stored in the terminal may be removed if the case where it is determined that the unlocking reference information and the unlocking request information are different through the comparison therebetween is generated m more times according to an additional input of the unlocking request information or authentication failure information according to at least one other authentication scheme is generated.

6. The terminal of claim 1, wherein, when the count of the cases where it is determined that the unlocking reference information and the unlocking request information are different through the comparison therebetween exceeds n or when the security process for initializing the terminal is performed, the controller performs a security process for transmitting a terminal security emergency message and terminal position information to a management device of a communication service company of the terminal.

7. A service device for a data security service, the service device comprising:
a service execution unit for transmitting a data removal command for removing data stored in an internal or external storage device of a first terminal to the first terminal one or more times according to an execution request for a terminal data security service, receiving a data removal result, and processing a response to the execution request according to the data removal result; and
a communication unit for communicating with the first terminal.

8. The service device of claim 7, wherein the service execution unit receives the execution request for the terminal data security service including one or more of identification information of the first terminal, identification information of an owner of the first terminal or a representative of the owner, identification of an execution requester of the terminal data security service, and identification information of a second terminal which can make the execution request for the terminal data security service, from the second terminal.

9. The service device of claim 7, further comprising a service registration unit for storing and managing registration information of the terminal data security service that registers the terminal data security service to make the terminal data security service for the first terminal possible according to a registration request for the terminal data security service, wherein the service registration unit also stores one or more of identification information of the first terminal, identification information of an owner of the first terminal or a representative of the owner, identification of a registration requester of the terminal data security service, identification information of an execution requester who can make the execution request for the terminal data security service, and identification information of a second terminal which can make the execution request for the terminal data security service to correspond to the registration information of the terminal data security service when storing the registration information of the terminal data security service.

10. The service device of claim 7, wherein the service execution unit monitors whether the first terminal is in a state where communication with a communication service network is possible, and transmits the data removal command to the first terminal when the first terminal is in the state where the communication with the communication service network is possible.

11. The service device of claim 7, wherein the data removal command is one of a command for removing all user data stored in the internal or external storage device of the first terminal, a command for formatting the internal or external storage device of the first terminal, and a command for initializing the first terminal.

12. The service device of claim 7, wherein, when the execution request for the terminal data security service is received, the service execution unit controls to stop a call originating function of the first terminal.

13. The service device of claim 7, wherein the service execution unit transmits a backup data removal command for removing backup data of the data stored in the internal or external storage device of the first terminal from a backup device to the backup device one or more times according to an execution request for a backup data security service, receiving a backup data removal result, and processing a response to the execution request according to the backup data removal result, and the communication unit communicates with the backup device.

14. The service device of claim 13, wherein the service execution unit receives the execution request for the backup data security service including one or more of identification information of the first terminal, identification information of an owner of the first terminal or a representative of the owner, identification of an execution requester of the backup data security service, and information related to an access to the backup device from a second terminal.

15. The service device of claim 13, further comprising a service registration unit for storing and managing registration information of the backup data security service to make the backup data security service possible according to a registration request for the backup data security service.

16. The service device of claim 13, wherein the service registration unit also stores backup data removal control information for removing backup data backed up onto the backup device when storing the registration information of the backup data security service, and the backup data removal control information includes information for identifying the backup device or information for proving that the backup device is allowed to remove the backup data.

17. The service device of claim 13, wherein the service registration unit also stores identification information of the first terminal, identification information of an owner of the first terminal or a representative of the owner, identification information of an execution requester of the backup data security service, and identification information of a second terminal which can make the execution request for the backup data security service to correspond to the registration information of the backup data security service when storing the registration information of the backup data security service.

18. A terminal for a data security service, the terminal comprising:
an internal or external storage device for storing data;
a data removal processor for, when receiving a data removal command for removing the data stored in the internal or external storage device from a service device, performing a data removal process for the internal or external storage device and transmitting a data removal result to the service device; and
a communication unit for communicating with the service device.

19. The terminal of claim 18, wherein, when the data removal processor identifies that an execution request for the terminal data security service has been generated from a communication service network even though the data removal processor has not received the data removal command, the data removal processor performs the data removal process by itself to remove the data and stores a data removal result, and transmits the stored data removal result to the service device when the data removal processor attains a state where communication with the service device is possible.

20. The terminal of claim 18, wherein the controller provides an interface that registers, in the service device, the backup data security service for removing the backup data of the data stored in the internal or external storage device, backed up onto the backup device.
